(19) United States
(12) Patent Application Publication
(10) Pub. No.: US 2017/0106447 A1
(43) Pub. Date: Apr. 20, 2017

(54) MANUFACTURING METHOD FOR THREE-DIMENSIONAL FORMED OBJECT AND MANUFACTURING APPARATUS FOR THREE-DIMENSIONAL FORMED OBJECT

(71) Applicant: SEIKO EPSON CORPORATION, Tokyo (JP)

(72) Inventors: Masaya ISHIDA, Hara-mura (JP); Takeshi Miyashita, Suwa (JP); Eiji Okamoto, Matsumoto (JP); Kentaro Yamada, Matsumoto (JP)

(21) Appl. No.: 15/294,486

(22) Filed: Oct. 14, 2016

(30) Foreign Application Priority Data
Oct. 15, 2015 (JP) 2015-203473

(51) Int. Cl. B22F 7/02; B33Y 10/00; C04B 37/02; B33Y 50/02; B22F 3/105; B28B 1/00; B33Y 30/00

(52) U.S. Cl. CPC B22F 7/02; B28B 1/001; B33Y 10/00; B33Y 30/00; B33Y 50/02; B22F 3/1055; C04B 37/021; B22F 2003/1057; B22F 2998/10; C04B 2237/343; C04B 2237/341; C04B 2237/366; C04B 2237/365; C04B 2237/368; C04B 2237/40; C04B 2237/406; C04B 2237/407; C04B 2237/405; C04B 2237/403; C04B 2237/402

(57) ABSTRACT

A manufacturing method for a three-dimensional formed object for manufacturing the three-dimensional formed object by stacking layers includes supplying a first supply object including a first material to a supporting body and sintering the first material to thereby solidify the first material to form a first layer and supplying a second supply object including a second material having a melting point or a sintering temperature lower than a sintering temperature of the first material to be superimposed on the first layer and sintering or melting the second material to thereby solidify the second material to form a second layer.

### BACKGROUND

### 1. Technical Field

The present invention relates to a manufacturing method for a three-dimensional formed object and a manufacturing apparatus for a three-dimensional formed object.

### 2. Related Art

A manufacturing method for manufacturing a three-dimensional formed object by stacking layers has been carried out. As such a manufacturing method for the three-dimensional formed object, in general, a three-dimensional formed object is formed on a supporting body. However, in such a manufacturing method in the past for manufacturing a three-dimensional formed object by stacking layers, separating work for removing the three-dimensional formed object formed on the supporting body from the supporting body, forming work after the removal, and the like cause a large burden. That is, time and labor are consumed for post-treatment processes performed after the three-dimensional formed object is formed on the supporting body.

Therefore, for example, JP-A-2012-106437 (Patent Literature 1) discloses a manufacturing method for a three-dimensional formed object capable of reducing the post-treatment processes by forming a support layer between the supporting body (a forming stage) and the three-dimensional formed object.

However, simply by forming the support layer for the three-dimensional formed object between the supporting body and the three-dimensional formed object, the burden of the separating work for removing the three-dimensional formed object formed on the supporting body from the supporting body, the forming work after the removal, and the like sometimes cannot be sufficiently reduced. This is because the magnitude of such a burden changes depending on, for example, materials forming the supporting body, the three-dimensional formed object, and the support layer.

Therefore, in the manufacturing method in the past for manufacturing a three-dimensional formed object by stacking layers, the post-treatment processes for the three-dimensional formed object to be manufactured cannot be sufficiently reduced.

### SUMMARY

An advantage of some aspects of the invention is to reduce post-treatment processes for a three-dimensional formed object to be manufactured in a manufacturing method for a three-dimensional formed object for manufacturing the three-dimensional formed object by stacking layers.

A first aspect of the invention is directed to a manufacturing method for a three-dimensional formed object for manufacturing the three-dimensional formed object by stacking layers, the manufacturing method for the three-dimensional formed object including: forming a first layer by supplying a first supply object including a first material to a supporting body and sintering the first material to thereby solidify the first material; and forming a second layer by supplying a second supply object including a second material having a melting point or a sintering temperature lower than a sintering temperature of the first material to be superimposed on the first layer and sintering or melting the second material to thereby solidify the second material.

According to this aspect, the first material is solidified by being sintered on the supporting body to form the first layer. The second material having the melting point or the sintering temperature lower than the sintering temperature of the first material is solidified by being sintered or melted to be superimposed on the first layer to form the second layer. Therefore, it is possible to easily form a discontinuous layer in a state in which the first layer is solidified and a state in which the second layer is solidified. It is possible to easily suppress, by forming the discontinuous layer, the first layer and the second layer from being strongly joined. Therefore, it is possible to suppress a situation in which the first material of the first layer serving as a base in forming the three-dimensional formed object and a forming material of the three-dimensional formed object are sintered in the same manner to be strongly joined and a burden of separating work for removing the second layer (the three-dimensional formed object) from the first layer (the base) increases. That is, by using a material having a melting point or a sintering temperature lower than the sintering temperature of the first material as the second material, which is the forming material of the three-dimensional formed object, it is possible to reduce the burden of the separating work for removing the second layer (the three-dimensional formed object) from the first layer (the base).

A second aspect of the invention is directed to the manufacturing method for the three-dimensional formed object according to the first aspect, in which the manufacturing method for the three-dimensional formed object further includes stacking one or more layers by executing the supply of the second supply object and the sintering or the melting of the second material on the second layer.

According to this aspect, the manufacturing method for the three-dimensional formed object includes the executing the supply of the second supply object and the sintering or the melting of the second material to stack one or more layers on the second layer. Therefore, it is possible to easily form a three-dimensional formed object having a desired shape and a desired size by repeating the stacking one or more layers a number of times corresponding to necessity.

A third aspect of the invention is directed to the manufacturing method for the three-dimensional formed object according to the second aspect, in which the manufacturing method for the three-dimensional formed object further includes supplying a third supply object and forming a support layer that supports the second supply object supplied in the stacking one or more layers.

According to this aspect, the third supply object is supplied to form the support layer that supports the second supply object supplied in the stacking one or more layers. Therefore, when an undercut section (a portion convex in a plane direction with respect to a lower layer) is present in an upper layer among the layers stacked in the stacking one or more layers, it is possible support the undercut section with the support layer.

A fourth aspect of the invention is directed to the manufacturing method for the three-dimensional formed object according to any one of the first to third aspects, in which a melting point of the supporting body is lower than the sintering temperature of the first material.

According to this aspect, the melting point of the supporting body is lower than the melting point of the first material. That is, the first material has the melting point different from not only the melting point of the second material but also the melting point of the supporting body. Therefore, it is possible to not only reduce the burden of the separating work for removing the second layer from the first layer but also reduce a burden of separating work for removing the first layer from the supporting body.

A fifth aspect of the invention is directed to the manufacturing method for the three-dimensional formed object according to any one of the first to fourth aspects, in which a coefficient of linear expansion of the first material is smaller than a coefficient of linear expansion of the second material and a coefficient of linear expansion of the supporting body.

According to this aspect, the coefficient of linear expansion of the first material is smaller than the coefficients of linear expansion of both of the second material and the supporting body. Since the coefficient of linear expansion of the first layer (the first material) is set smaller than the coefficients of linear expansion of the second layer (the second material) and the supporting body, film stresses in opposite directions acts between the first layer and the second layer/the supporting body according to heating. It is possible to suppress the three-dimensional formed object from being distorted. Therefore, it is possible to reduce the burden of the separating work for removing the second layer from the first layer and the burden of the separating work for removing the first layer from the supporting body.

A sixth aspect of the invention is directed to the manufacturing method for the three-dimensional formed object according to any one of the first to fifth aspects, in which, in the forming the first layer, a through-hole piercing to the supporting body is formed in the first layer.

According to this aspect, the through-hole piercing to the supporting body is formed in the first layer. Therefore, for example, by supplying a material having high thermal conductivity (the second material, etc.) to the through-hole, it is possible to allow heat involved in the sintering or the melting of the second material to escape via the through-hole. For example, by supplying the second material to the through-hole and sintering or melting the second material to form the second layer together with this portion, it is possible to increase a fixing force of the second layer to the first layer.

A seventh aspect of the invention is directed to the manufacturing method for the three-dimensional formed object according to any one of the first to sixth aspects, in which at least one of the first supply object and the second supply object is supplied by a noncontact jet dispenser.

According to this aspect, at least one of the first supply object and the second supply object is supplied by the noncontact jet dispenser. The noncontact jet dispenser is capable of discharging and disposing the material at a short cycle. Therefore, it is possible to increase the manufacturing speed of the three-dimensional formed object.

An eighth aspect of the invention is directed to the manufacturing method for the three-dimensional formed object according to any one of the first to sixth aspects, in which at least one of the first supply object and the second supply object is supplied by a needle dispenser.

According to this aspect, at least one of the first supply object and the second supply object is supplied by the needle dispenser. The needle dispenser is capable of finely adjusting an amount of the material and disposing the material. Therefore, it is possible to increase the manufacturing accuracy of the three-dimensional formed object.

A ninth aspect of the invention is directed to the manufacturing method for the three-dimensional formed object according to any one of the first to eighth aspects, in which the first material includes at least one of alumina, silica, aluminum nitride, silicon carbide, and silicon nitride, and the second material includes at least one of magnesium, iron, copper, cobalt, titanium, chrome, nickel, aluminum, maraging steel, stainless steel, cobalt chrome molybdenum, a titanium alloy, a nickel alloy, an aluminum alloy, a cobalt alloy, and a cobalt chrome alloy.

According to this aspect, it is possible to reduce post-treatment processes for the three-dimensional formed object to be manufactured and it is possible to manufacture a three-dimensional formed object having particularly high rigidity.

A tenth aspect of the invention is directed to the manufacturing method for the three-dimensional formed object according to the any one of first to ninth aspects, in which temperature for solidifying the second material in the forming the second layer is equal to or lower than the sintering temperature of the first material.

According to this aspect, the temperature for solidifying the second material in the forming the second layer is equal to or lower than the sintering temperature of the first material. Therefore, it is possible to suppress a situation in which both of the first layer and the second layer are sintered and strongly joined and the burden of the separating work for removing the second layer from the first layer increases.

An eleventh aspect of the invention is directed to a manufacturing apparatus for a three-dimensional formed object that manufactures the three-dimensional formed object by stacking layers, the manufacturing apparatus for the three-dimensional formed object including: a first-layer forming section configured to supply a first supply object including a first material to a supporting body and sinter the first material to thereby solidify the first material to form a first layer; and a second-layer forming section configured to supply a second supply object including a second material having a melting point or a sintering temperature lower than a sintering temperature of the first material to be superimposed on the first layer and sinter or melt the second material to thereby solidify the second material to form a second layer.

According to this aspect, the first material is solidified by being sintered on the supporting body to form the first layer. The second material having the melting point or the sintering temperature lower than the sintering temperature of the first material is solidified by being sintered or melted to be superimposed on the first layer to form the second layer. Therefore, it is possible to easily form a discontinuous layer in a state in which the first layer is solidified and a state in which the second layer is solidified. It is possible to easily suppress, by forming the discontinuous layer, the first layer and the second layer from being strongly joined. Therefore, it is possible to suppress a situation in which the first material of the first layer serving as a base in forming the three-dimensional formed object and a forming material of the three-dimensional formed object are sintered in the same manner to be strongly joined and a burden of separating work for removing the second layer (the three-dimensional formed object) from the first layer (the base) increases. That is, by using a material having a melting point or a sintering temperature lower than the sintering temperature of the first material as the second material, which is the forming material of the three-dimensional formed object, it is possible to reduce the burden of the separating work for removing the second layer (the three-dimensional formed object) from the first layer (the base).

### BRIEF DESCRIPTION OF THE DRAWINGS

The invention will be described with reference to the accompanying drawings, wherein like numbers reference like elements.

FIG. 1A is a schematic configuration diagram showing the structure of a manufacturing apparatus for a three-dimensional formed object according to an embodiment of the invention.

FIG. 1B is an enlarged view of a C′ part shown in FIG. 1A.

FIG. 2A is a schematic configuration diagram showing the configuration of the manufacturing apparatus for the three-dimensional formed object according to the embodiment of the invention.

FIG. 2B is an enlarged view of a C part shown in FIG. 2A.

FIG. 3 is a schematic perspective view of a head base according to the embodiment of the invention.

FIGS. 4A to 4C are plan views for conceptually explaining a relation between the disposition of head units and a formation form of a molten section according to the embodiment of the invention.

FIGS. 5A and 5B are schematic diagrams for conceptually explaining the formation form of the molten section.

FIGS. 6A and 6B are schematic diagrams showing examples of other kinds of disposition of the head unit disposed in the head base.

FIGS. 7A to 7F are schematic diagrams showing a manufacturing process for a three-dimensional formed object according to the embodiment of the invention.

FIGS. 8A to 8H are schematic diagrams showing a manufacturing process for a three-dimensional formed object according to the embodiment of the invention.

FIG. 9 is a flowchart of a manufacturing method for a three-dimensional formed object according to the embodiment of the invention.

### DESCRIPTION OF EXEMPLARY EMBODIMENTS

An embodiment of the invention is explained below with reference to the drawings.

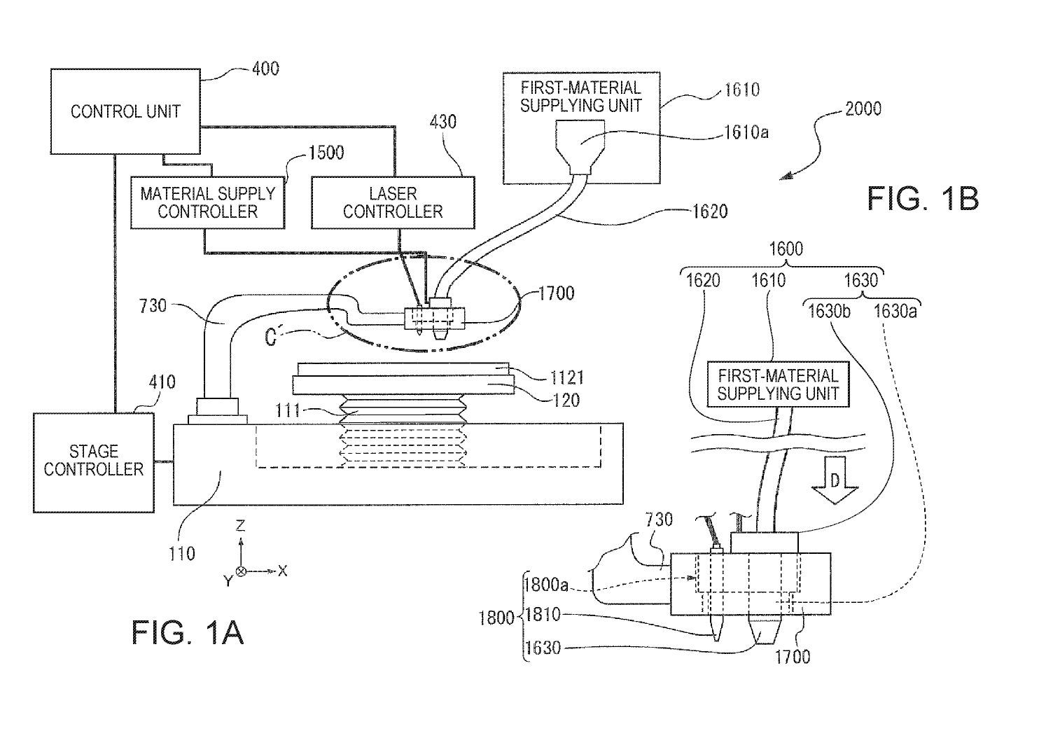

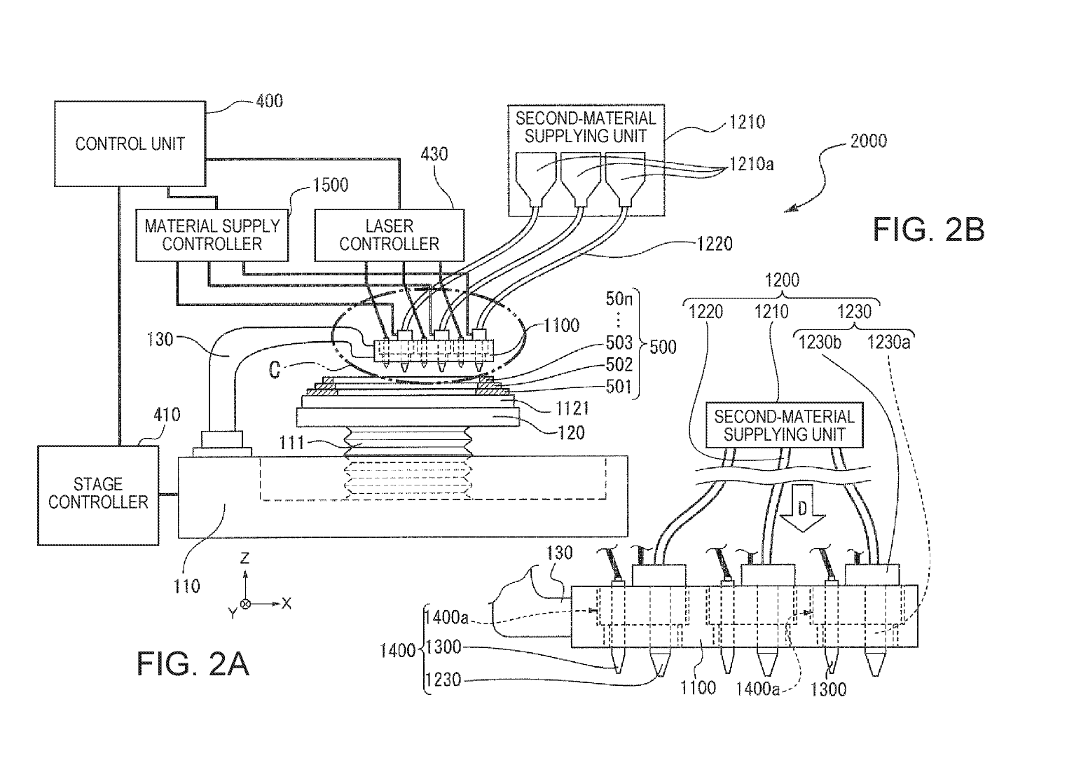

FIGS. 1A to 2B are schematic configuration diagrams showing the configurations of a manufacturing apparatus for a three-dimensional formed object according to an embodiment of the invention.

The manufacturing apparatus for the three-dimensional formed object in this embodiment includes two kinds of material supplying sections and two kinds of energy applying sections. However, FIGS. 1A to 2B are diagrams each showing only one material supplying section and one energy applying section. The other material supplying section and the other energy applying section are omitted.

The manufacturing apparatus for the three-dimensional formed object according to this embodiment discharges two kinds of fluid supply objects (a first supply object and a second supply object) including a first material and a second material of different kinds to thereby supply the supply objects and forms a first layer serving as a base (a forming stage) in forming the three-dimensional formed object from the first supply object and a second layer for forming the three-dimensional formed object from the second supply object. However, the invention is not limited to such a manufacturing apparatus for the three-dimensional formed object. The first layer and the second layer may be formed by different methods. For example, the first layer and the second layer may be formed using a green sheet including the first material and a green sheet including the second material. The first material and the second material are not particularly limited.

Note that “three-dimensional forming” in this specification indicates formation of a so-called solid formed object. The “three-dimensional forming” also includes formation of a shape having thickness even if the shape is, for example, a flat shape, a so-called two-dimensional shape.

As shown in FIGS. 1A to 2B, a forming apparatus 2000 includes a base 110 and a stage 120 provided to be capable of being driven to move in X, Y, and Z directions shown in the figures or rotate in a rotating direction centering on a Z axis by a driving device 111 functioning as driving means included in the base 110. As shown in FIGS. 1A and 1B, the forming apparatus 2000 includes a head-base supporting section 730, one end portion of which is fixed to the base 110 and at the other end portion of which a head base 1700, which holds a head unit 1800 including an energy radiating section 1810 and a first-material discharging section 1630, is held and fixed. As shown in FIGS. 2A and 2B, the forming apparatus 2000 includes a head-base supporting section 130, one end portion of which is fixed to the base 110 and at the other end portion of which a head base 1100, which holds a plurality of head units 1400 including energy radiating sections 1300 and second-material discharging sections 1230, is held and fixed. The head base 1700 and the head base 1100 are provided in parallel on an XY plane.

Note that the energy radiating section 1810 in this embodiment has a configuration same as the configuration of the energy radiating sections 1300 except that a radiation range of energy is wider than a radiation range of energy of the energy radiating sections 1300. The first-material discharging section 1630 has a configuration same as the configuration of the second-material discharging sections 1230 except that a discharge amount of the first-material discharging section 1630 is larger than a discharge amount of the second-material discharging sections 1230. However, the forming apparatus 2000 is not limited to such a configuration.

As shown in FIG. 1A, a first supply object including ceramics particles serving as the first material is discharged onto the stage 120 from the first-material discharging section 1630. Thermal energy is radiated on the discharged first supply object from the energy radiating section 1810. A base section 1121 is formed in a layer shape.

As shown in FIG. 2A, a second supply object including metal powder serving as the second material is discharged onto the base section 1121 from the second-material discharging sections 1230. Thermal energy is radiated on the discharged second supply object from the energy radiating sections 1300. Consequently, partial formed objects 501, 502, and 503 in a process of being formed into a three-dimensional formed object 500 are formed in a layer shape. Note that, in FIG. 2A, for convenience of explanation, three layers of the partial formed objects 501, 502, and 503 are illustrated. However, layers are stacked up to a desired shape of the three-dimensional formed object 500 (a layer 50n shown in FIG. 2A).

FIG. 1B is a C′-part enlarged conceptual diagram showing the head base 1700 shown in FIG. 1A. As shown in FIG. 1B, one head unit 1800 is held in the head base 1700. The head unit 1800 is a forming section for a first layer and is configured by holding, with a holding jig 1800a, the first-material discharging section 1630 included in a first-material supplying device 1600 and the energy radiating section 1810. The first-material discharging section 1630 includes a discharge nozzle 1630a and a discharge driving section 1630b caused by a material supply controller 1500 to discharge the first supply object including the first material from the discharge nozzle 1630a.

FIG. 2B is a C-part enlarged conceptual diagram showing the head base 1100 shown in FIG. 2A. As shown in FIG. 2B, the plurality of head units 1400 are held in the head base 1100. As explained in detail below, one head unit 1400 is a forming section for a second layer and is configured by holding, with a holding jig 1400a, the second-material discharging section 1230 included in a second-material supplying device 1200 and the energy radiating section 1300. The second-material discharging section 1230 includes a discharge nozzle 1230a and a discharge driving section 1230b caused by the material supply controller 1500 to discharge the second supply object including the second material from the discharge nozzle 1230a.

The energy radiating sections 1810 and 1300 are explained as energy radiating sections that radiate a laser, which is an electromagnetic wave, as energy (in the following explanation, the energy radiating sections 1810 and 1300 are referred to as laser radiating sections 1810 and 1300). By using the laser as the energy to be radiated, it is possible to radiate the energy targeting a supply material set as a target. It is possible to form a high-quality three-dimensional formed object. It is possible to easily control a radiated energy amount (power and scanning speed) according to, for example, a type of a material to be discharged. It is possible to obtain a three-dimensional formed object having desired quality. For example, it goes without saying that it is also possible to select to sinter and solidify or melt and solidify the material to be discharged. That is, depending on a case, the material to be discharged is a sintered material, a melted material, or a solidified material solidified by another method. However, the forming apparatus 2000 is not limited to such a configuration. An energy applying section that applies heat generated by arc discharge may be provided instead of the laser radiating sections 1810 and 1300. The first layer and the second layer may be sintered or melted to be solidified with heat generated by the arc discharge.

The first-material discharging section 1630 is connected to, by a supply tube 1620, a first-material supplying unit 1610 that stores the first supply object associated with the heat unit 1800 held in the head base 1700. A predetermined first supply object is supplied from the first-material supplying unit 1610 to the first-material discharging section 1630. In the first-material supplying unit 1610, a material (ceramics) including a raw material of the first layer serving as a base (a forming stage) for forming the three-dimensional formed object 500 formed by the forming apparatus 2000 according to this embodiment is stored in a first-material storing section 1610a as a supply material. The first-material storing section 1610a is connected to the first-material discharging section 1630 by the supply tube 1620.

The second-material discharging sections 1230 are connected to, by supply tubes 1220, a second-material supplying unit 1210 that stores second supply materials respectively associated with the head units 1400 held in the head base 1100. Predetermined second supply objects are supplied from the second-material supplying unit 1210 to the second-material discharging sections 1230. In the second-material supplying unit 1210, materials (metal) including raw materials of the three-dimensional formed object 500 formed by the forming apparatus 2000 according to this embodiment are stored in second-material storing sections 1210a as supply materials. The respective second-material storing sections 1210a are connected to the respective second-material discharging sections 1230 by the supply tubes 1220. In this way, the second-material supplying unit 1210 includes the respective second-material storing sections 1210a. Consequently, it is possible to supply a plurality of different kinds of materials from the head base 1100.

The metal (the second material) of the second supply object supplied as the material is not particularly limited as long as the second material is a material having a melting point lower than a sintering temperature of the first material. It is possible to use, for example, powder of magnesium (Mg), iron (Fe), cobalt (Co), chrome (Cr), aluminum (Al), titanium (Ti), nickel (Ni), or copper (Cu) or a slurry-like (or paste-like) material including powder of an alloy containing one or more of these kinds of metal (maraging steel, stainless steel, cobalt chrome molybdenum, a titanium alloy, a nickel alloy, an aluminum alloy, a cobalt alloy, or a cobalt chrome alloy) or the like, a solvent, and a binder.

The forming apparatus 2000 includes a control unit 400 functioning as control means for controlling, on the basis of data for forming of a three-dimensional formed object output from a not-shown data output apparatus such as a personal computer, the stage 120, the first-material discharging section 1630 and the laser radiating section 1810 included in the first-material supplying device 1600 and the second-material discharging sections 1230 and the laser radiating sections 1300 included in the second-material supplying device 1200. The control unit 400 includes, although not shown in the figures, a control section that controls the stage 120, the first-material discharging section 1630, and the laser radiating section 1810 to be driven and operate in association with one another and controls the stage 120, the second-material discharging sections 1230, and the laser radiating sections 1300 to be driven and operate in association with one another. Control signals for the laser radiating sections 1300 and 1810 are sent from the control unit 400 to a laser controller 430. An output signal for radiating a laser is sent from the laser controller 430 to any ones or all of the plurality of laser radiating sections 1300 and the laser radiating section 1810.

For the stage 120 movably provided on the base 110, signals for controlling a movement start, a stop, a moving direction, a moving amount, moving speed, and the like of the stage 120 are generated in a stage controller 410 on the basis of a control signal from the control unit 400. The signals are sent to the driving device 111 included in the base 110. The stage 120 moves in the X, Y, and Z directions shown in the figures. For the first-material discharging section 1630 included in the head unit 1800, a signal for controlling a material discharge amount and the like from the discharge nozzle 1630a in the discharge driving section 1630b included in the first-material discharging section 1630 is generated in the material supply controller 1500 on the basis of a control signal from the control unit 400. A predetermined amount of the first material is discharged from the discharge nozzle 1630a according to the generated signal. Similarly, for the second-material discharging sections 1230 included in the welding rod unit 1400, signals for controlling material discharge amounts and the like from the discharge nozzles 1230a in the discharge driving sections 1230b included in the second-material discharging sections 1230 are generated in the material supply controller 1500 on the basis of a control signal from the control unit 400. Predetermined amounts of the second material are discharged from the discharge nozzles 1230a according to the generated signals.

The head unit 1400 is explained more in detail.

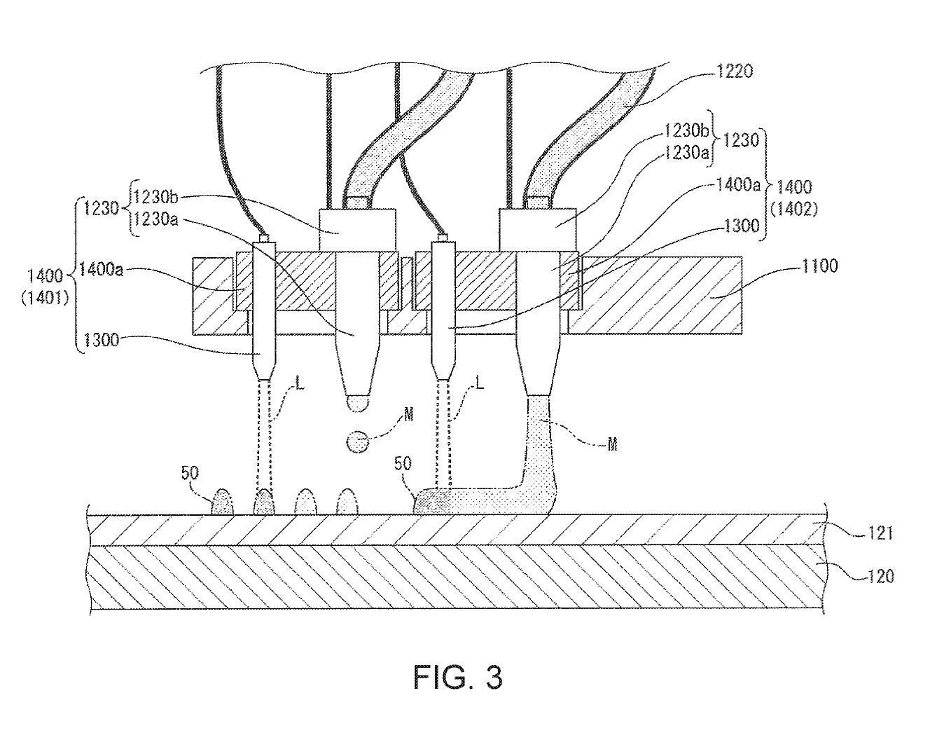

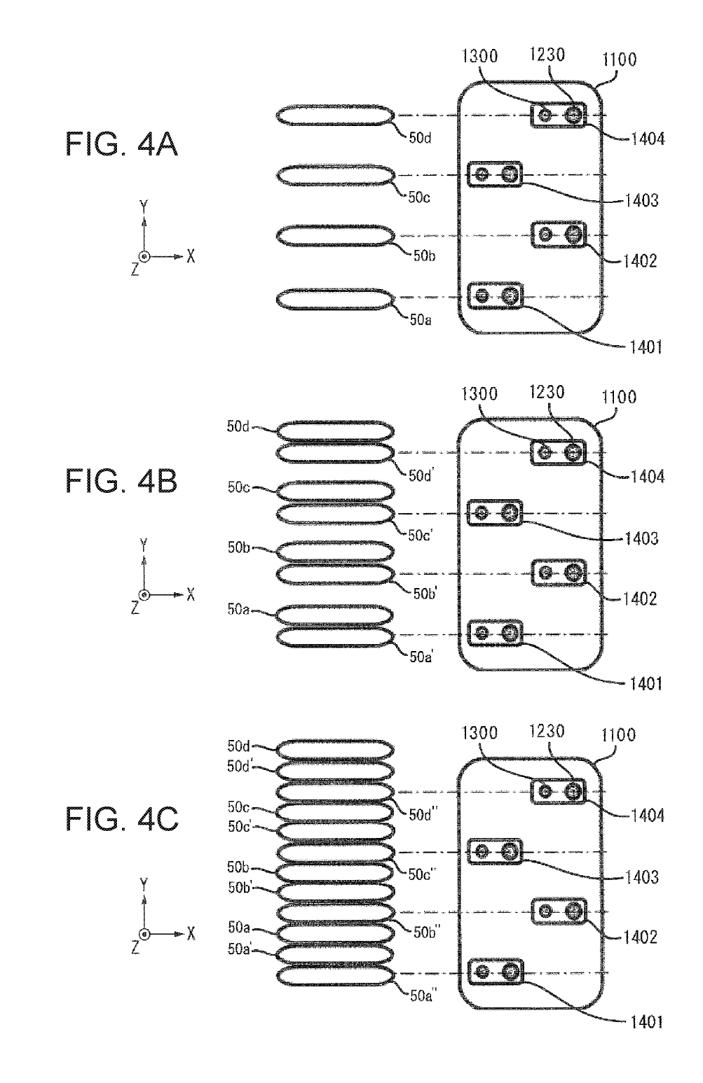

FIGS. 3 and 4A to 4C show an example of a holding form of the plurality of head units 1400 held in the head base 1100 and the laser radiating sections 1300 and the material discharging sections 1230 held by the head units 1400. FIGS. 4A to 4C are exterior views of the head base 1100 from an arrow D direction shown in FIG. 2B.

Note that, in the following explanation, an example is explained in which a desired region of a layer formed by the second supply object is melted and solidified. However, the desired region may be sintered and solidified at temperature lower than temperature for the melting.

As shown in FIG. 3, the plurality of head units 1400 are held in the head base 1100 by not-shown fixing means. As shown in FIGS. 4A to 4C, the head base 1100 of the forming apparatus 2000 according to this embodiment includes the head units 1400 in which four units, that is, a head unit 1401 in a first row, a head unit 1402 in a second row, a head unit 1403 in a third row, and a head unit 1404 in a fourth row are disposed in a zigzag from the bottoms of the figures. As shown in FIG. 4A, the forming materials are discharged from the head units 1400 while moving the stage 120 in the X direction with respect to the head base 1100. Lasers L are radiated from the laser radiating sections 1300 to form molten sections 50 (molten sections 50a, 50b, 50c, and 50d). A formation procedure for the molten sections 50 is explained below.

Note that, although not shown in the figure, the second-material discharging sections 1230 included in the respective head units 1401 to 1404 are connected to the second-material supplying unit 1210 by the supply tubes 1220 via the discharge driving sections 1230b. The laser radiating sections 1300 are connected to the laser controller 430 and held by the holding jigs 1400a.

As shown in FIG. 3, a material M (in this embodiment, corresponding to the second supply object and hereinafter referred to as a material M) is discharged from the discharge nozzles 1230a of the second-material discharging sections 1230 onto the base section 1121 placed on the stage 120. In the head unit 1401, a discharge form in which the material M is discharged in a droplet state is illustrated. In the head unit 1402, a discharge form in which the material M is supplied in a continuous body state is illustrated. The discharge form of the material M may be either the droplet state or the continuous body state. However, in this embodiment, a form in which the material M is discharged in the droplet state is explained.

The material M discharged from the discharge nozzle 1230a in the droplet state flies substantially in the gravity direction and arrives on the base section 1121. The laser radiating section 1300 is held by the holding jig 1400a. When the material M arriving on the base section 1121 enters a laser radiation range according to the movement of the stage 120, the material M melts. Outside the laser radiation range, the material M solidifies and the molten sections 50 are formed. An aggregate of the molten sections 50 is formed as a partial formed object, for example, the partial formed object 501 (see FIG. 2A) of the three-dimensional formed object 500 formed on the base section 1121.

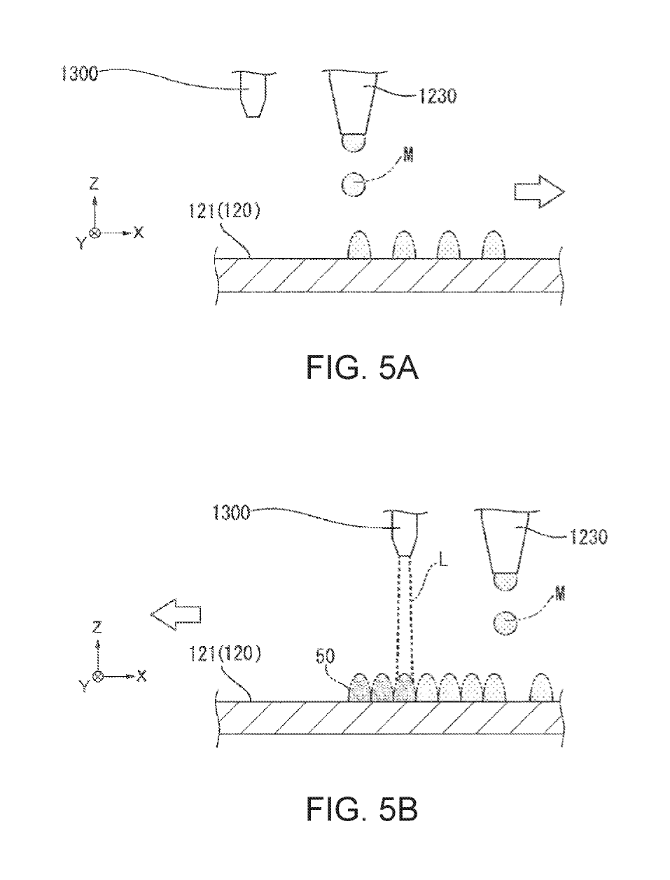

A formation procedure for the molten sections 50 is explained with reference to FIGS. 4A to 5B.

FIGS. 4A to 4C are plan views for conceptually explaining a relation between the disposition of the head units 1400 and a formation form of the molten sections 50 in this embodiment. FIGS. 5A and 5B are side views for conceptually showing the formation form of the molten sections 50.

First, when the stage 120 moves in a +X direction, the material M is discharged from the plurality of discharge nozzles 1230a in the droplet state. The material M is disposed in predetermined positions of the base section 1121. When the stage 120 further moves in the +X direction, the material M enters the radiation range of the laser L radiated from the laser radiating sections 1300 and melts. When the stage 120 further moves in the +X direction, the material M exits the radiation range of the laser L and solidifies and the molten sections 50 are formed.

More specifically, first, as shown in FIG. 5A, the material M is disposed in the predetermined positions of the base section 1121 at fixed intervals from the plurality of discharge nozzles 1230a while moving the stage 120 in the +X direction.

Subsequently, as shown in FIG. 5B, while moving the stage 120 in a −X direction shown in FIG. 1A, the material M is disposed anew to fill spaces among the predetermined positions where the material M is disposed at the fixed intervals. When the stage 120 is continuously moved in the −X direction, the material M enters the radiation range of the laser L and is melted (the molten sections 50 are formed).

Note that time from the disposition of the material M in the predetermined positions until the material M enters the radiation range of the laser L can be adjusted according to moving speed of the stage 120. For example, when a solvent is included in the material M, it is possible to facilitate drying of the solvent by reducing the moving speed of the stage 120 and increasing the time until the material M enters the radiation range.

A configuration may be adopted in which, while moving the stage 120 in the +X direction, the material M is disposed to overlap (not to be spaced apart) in the predetermined positions of the base section 1121 from the plurality of discharge nozzles 1230a and enters the radiation range of the laser L while being kept moving in the same direction (the molten sections 50 are formed by only movement on one side in the X direction of the stage 120 rather than being formed by reciprocating movement in the X direction of the stage 120).

By forming the molten sections 50 as explained above, the molten sections 50 (the molten sections 50a, 50b, 50c, and 50d) for one line in the X direction (a first line in a Y direction) of the head units 1401, 1402, 1403, and 1404 shown in FIG. 4A are formed.

Subsequently, in order to form the molten sections 50 (the molten sections 50a, 50b, and 50c) in a second line in the Y direction of the head units 1401, 1402, 1403, and 1404, the head base 1100 is moved in a −Y direction. As a moving amount, when a pitch between the nozzles is represented as P, the head base 1100 is moved in the −Y direction by P/n (n is a natural number) pitch. In this embodiment, n is assumed to be 3.

By performing operation same as the operation explained above shown in FIGS. 5A and 5B, molten sections 50′ (molten sections 50a′, 50b′, 50c′, and 50d′) in the second line in the Y direction shown in FIG. 4B are formed.

Subsequently, in order to form the molten sections 50 (the molten sections 50a, 50b, 50c, and 50d) in a third line in the Y direction of the head units 1401, 1402, 1403, and 1404, the head base 1100 is moved in the −Y direction. As a moving amount, the head base 1100 is moved in the −Y direction by P/3 pitch.

By performing operation same as the operation explained above shown in FIGS. 5A and 5B, molten sections 50″ (molten sections 50a″, 50b″, 50c″, and 50d″) in the third line in the Y direction shown in FIG. 4B are formed. The molten layer can be obtained.

As the material M discharged from the material discharging sections 1230, the second material different from the second material discharged from the other head units can also be supplied from one or two or more units of the head units 1401, 1402, 1403, and 1404. Therefore, by using the forming apparatus 2000 according to this embodiment, it is possible to obtain a three-dimensional formed object including a composite material portion formed object formed from different kinds of materials.

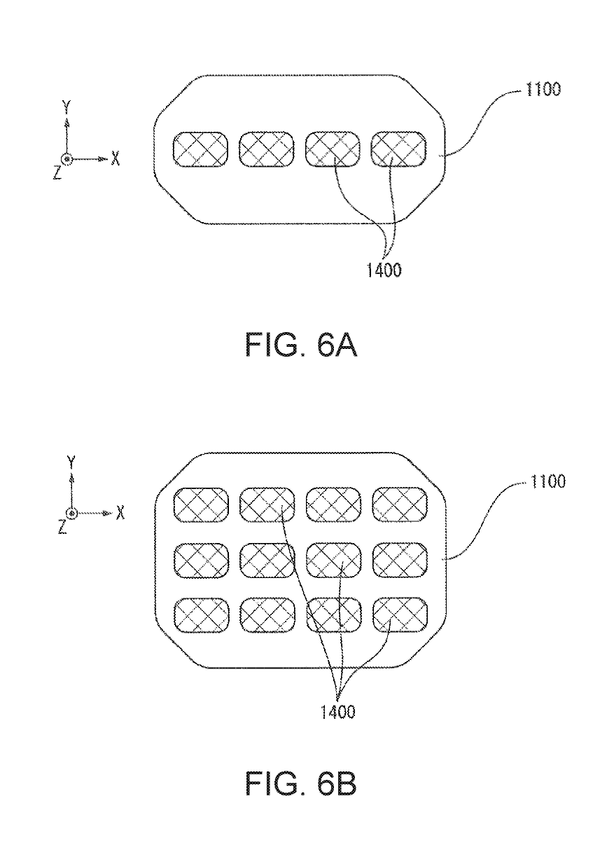

The number and the array of the head units 1400 and the head unit 1800 included in the forming apparatus 2000 according to the embodiment are not limited to the number and the array explained above. In FIGS. 6A and 6B, as examples of the number and the disposition, examples of other kinds of disposition of the head units 1400 disposed on the head base 1100 are schematically shown.

FIG. 6A shows a form in which the plurality of head units 1400 are arrayed in parallel in the X-axis direction on the head base 1100. FIG. 6B shows a form in which the head units 1400 are arrayed in a lattice shape on the head base 1100. Note that, in both the figures, the number of arrayed head units is not limited to the examples shown in the figure.

An example of a manufacturing method for a three-dimensional formed object performed using the forming apparatus 2000 according to this embodiment is explained.

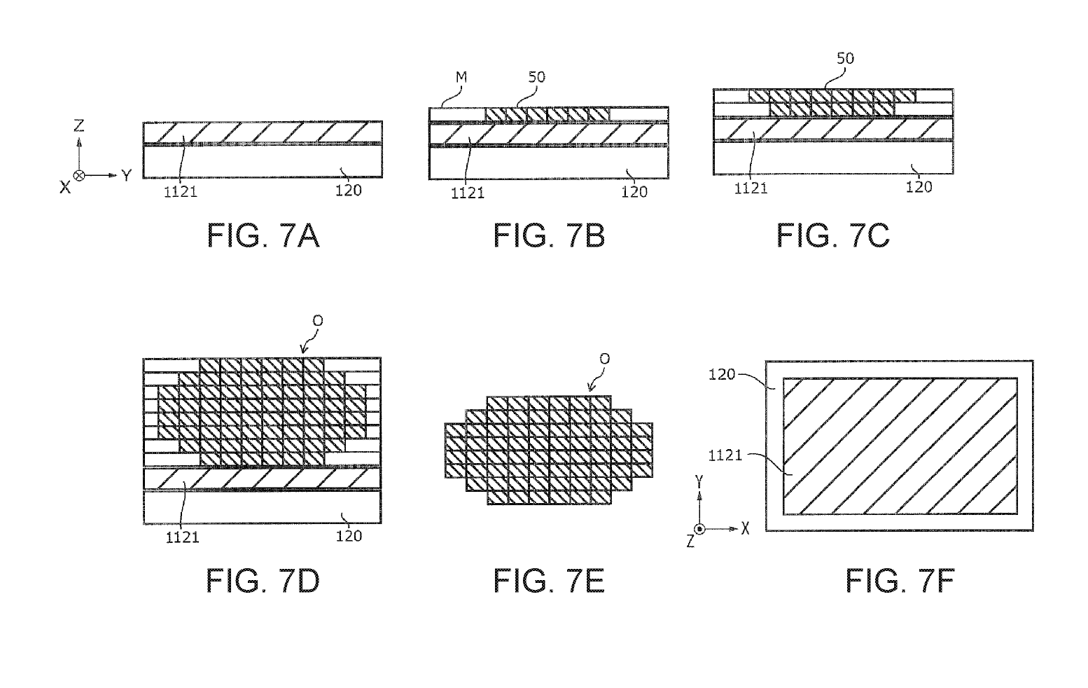

FIGS. 7A to 7G are schematic diagrams showing an example of a manufacturing process for a three-dimensional formed object performed using the forming apparatus 2000.

First, as shown in FIG. 7A, the first supply object for forming the first layer serving as the base (the forming stage: the base section 1121) for forming a three-dimensional formed object is supplied from the first-material discharging section 1630 onto the stage 120. The first layer (the base section 1121) is formed by radiating the laser L on the entire first supply object from the laser radiating section 1810. Note that FIG. 7A and FIGS. 7B to 9E referred to below are views from a direction along the X axis. FIG. 7F is shows a state in which a state shown in FIG. 7A is viewed from a direction along the Z axis.

Subsequently, as shown in FIG. 7B, the material M (the second supply object) for forming the bottom layer (the first layer) and forming the second layer of the three-dimensional formed object is supplied from the second-material discharging sections 1230 to the base section 1121 to be stacked on the upper side (a Z (+) direction). The molten sections 50 (the second layer) are formed by radiating the lasers L on a corresponding region of a desired three-dimensional formed object in the material M from the laser radiating sections 1300. Note that, when the material M is supplied onto the base section 1121, the material M is supplied to not only the corresponding region of the three-dimensional formed object but also a portion other than the corresponding region of the three-dimensional formed object. This is because, when an undercut section (a portion convex in the XY plane direction with respect to a lower layer) is present in an upper layer, the second layer supports the undercut section as a support layer in the lower layer. In the lower layer, the material M may be sintered by radiating the laser beams L from the laser radiating sections 1300.

The operation shown in FIG. 7B is repeated until the desired three-dimensional formed object is formed.

Specifically, as shown in FIG. 7C, by executing an operation same as the operation shown in FIG. 7B, a layer of the molten sections 50 to be formed as a second layer is formed to be stacked on the upper side of the layer of the molten sections 50 in the first layer. Note that, when the material M to be formed as the second layer is supplied to the material M of the first layer, the material M is supplied to not only the corresponding region of the three-dimensional formed object but also the portion other than the corresponding region of the three-dimensional formed object.

By repeating the operation shown in FIG. 7B (the operation shown in 7C) in this way, as shown in FIG. 7D, a complete body O of the three-dimensional formed object is completed. Note that FIG. 7E shows a state in which the complete body O of the three-dimensional formed object is removed from the base section 1121 and developed (deposits deriving from the material M are removed from the complete body O of the three-dimensional formed object).

Another example of the manufacturing method for the three-dimensional formed object performed using the forming apparatus 2000 according to the embodiment is explained.

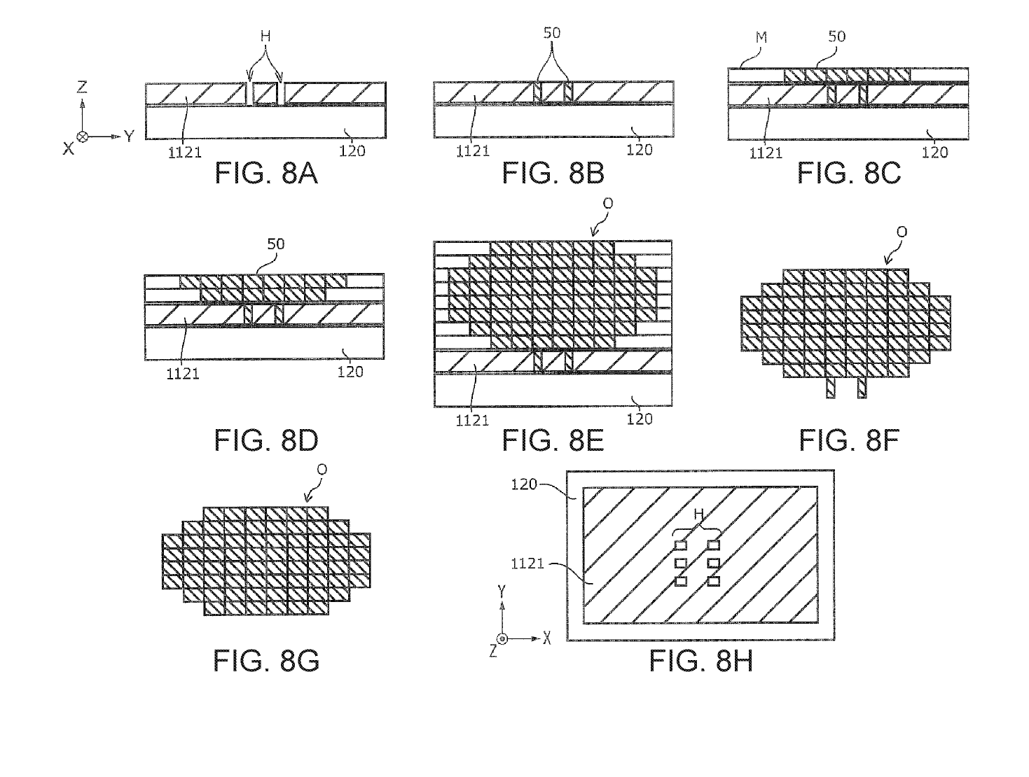

FIGS. 8A to 8H are schematic diagrams showing another example of the manufacturing process for the three-dimensional formed object performed using the forming apparatus 2000.

First, as shown in FIG. 8A, the first supply object for forming the first layer serving as the base (the forming stage) for forming the three-dimensional formed object is supplied from the first-material discharging section 1630 onto the stage 120. The first layer (the base section 1121) is formed by radiating the laser L on the entire first supply object from the laser radiating section 1810. Note that FIG. 8A and FIGS. 8B to 10G referred to below are views from the direction along the X axis. FIG. 8H shows a state in which a state shown in FIG. 8A is viewed from the direction along the Z axis. As shown in FIGS. 8A and 8H, in this example, through-holes H piercing to the stage 120 are formed in the base section 1121.

Subsequently, as shown in FIG. 8B, the material M is supplied from the second-material discharging sections 1230 to the through-holes H formed in the base section 1121. The laser L is radiated from the laser radiating sections 1300 to form the molten sections 50.

Subsequently, as shown in FIG. 8C, the material M (the second supply object) for forming the bottom layer (the first layer) and forming the second layer of the three-dimensional formed object is supplied from the second-material discharging sections 1230 to the base section 1121 to be stacked on the upper side (the Z (+) direction). The molten sections 50 (the second layer) are formed by radiating the lasers L on a corresponding region of a desired three-dimensional formed object in the material M from the laser radiating sections 1300. Note that, when the material M is supplied onto the base section 1121, the material M is supplied to not only the corresponding region of the three-dimensional formed object but also a portion other than the corresponding region of the three-dimensional formed object.

The operation shown in FIG. 8C is repeated until the desired three-dimensional formed object is formed.

Specifically, as shown in FIG. 8D, by executing an operation same as the operation shown in FIG. 8C, a layer of the molten sections 50 to be formed as a second layer is formed to be stacked on the upper side of the layer of the molten sections 50 in the first layer. Note that, when the material M to be formed as the second layer is supplied to the material M of the first layer, the material M is supplied to not only the corresponding region of the three-dimensional formed object but also the portion other than the corresponding region of the three-dimensional formed object.

By repeating the operation shown in FIG. 8C (the operation shown in FIG. 8D) in this way, as shown in FIG. 8E, the complete body O of the three-dimensional formed object is completed. Note that FIG. 8F shows a state in which the complete body O of the three-dimensional formed object is removed from the base section 1121 and developed (deposits deriving from the material M are removed from the complete body O of the three-dimensional formed object). FIG. 8G shows a state in which the molten sections 50 in portions corresponding to the through holes H (unnecessary portions) are cut to mold the three-dimensional formed object.

Note that examples other than the manufacturing method for the three-dimensional formed object performed using the forming apparatus 2000 according to the embodiment include forms explained below.

For example, it is possible to adopt a method of radiating to the molten section 50 a laser on a contact region in contact with a contour region of the three-dimensional formed object to heat the contact region and spraying metal powder to the radiated region as the second material. By adopting such a method, the three-dimensional formed object to be formed does not need to be conductive. Therefore, it is possible to use a nonconductive material such as a resin material as the second material. As another embodiment, a dispenser (a material supplying section) and a laser radiating section can be disposed as separate units. It is also possible to set a laser radiating section, a plurality of mirrors for positioning a laser beam from the laser radiating section, a lens system for converging the laser beam, and the like above the stage 120, adopt a galvanometer scanner system for scanning the laser beam at high speed and in a wide range, and solidify the material.

As another example, for example, it is possible to adopt a method of forming the second layer using, instead of the first-material discharging section 1630 and the second-material discharging sections 1230 that discharge the first supply object and the second supply object as droplets, a needle dispenser that deposits the materials at a needle tip and disposes the materials in predetermined positions. By adopting such a method, it is possible to improve fineness of the shape of the three-dimensional formed object.

An example (an example corresponding to FIGS. 7A to 7F) of a manufacturing method for a three-dimensional formed object performed using the forming apparatus 2000 according to the embodiment is explained with reference to a flowchart.

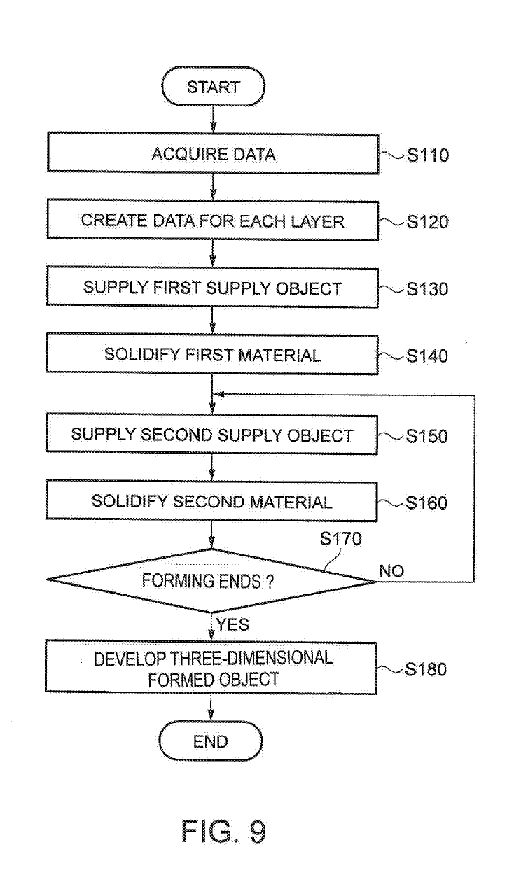

FIG. 9 is a flowchart of a manufacturing method for a three-dimensional formed object in this embodiment.

As shown in FIG. 9, in the manufacturing method for the three-dimensional formed object in this embodiment, first, in step S110, data of the three-dimensional formed object is acquired. Specifically, data representing the shape of the three-dimensional formed object is acquired from, for example, an application program executed in a personal computer.

Subsequently, in step S120, data for each layer is created. Specifically, in the data representing the shape of the three-dimensional formed object, the three-dimensional formed object is sliced according to forming resolution in the Z direction to generate bitmap data (sectional data) for each cross section.

The bitmap data generated in this case is data distinguished by a contour region of the three-dimensional formed object and the contact region of the three-dimensional formed object.

Subsequently, in step S130, the first supply object including the first material, which is a constituent material of the base section 1121, is discharged from the first-material discharging section 1630 and supplied to the stage 120.

Subsequently, in step S140, the base section 1121 serving as the first layer is formed by radiating the laser L on an entire supply range of the first supply object from the laser radiating section 1810. In this embodiment, the first supply object is solidified by sintering.

Subsequently, in step S150, the second supply object including the second material, which is a forming material of the three-dimensional formed object, is discharged from the second-material discharging sections 1230 and supplied to the contact region on the layer formed in step S140.

Subsequently, in step S160, the molten sections 50 serving as the second layer are formed by radiating the lasers L on a corresponding region of the three-dimensional formed object from the laser radiating sections 1300. In this embodiment, the second supply object is solidified by melting. However, the second supply object maybe solidified by another method such as sintering.

Steps S150 to S170 are repeated until the forming of the three-dimensional formed object based on the bitmap data corresponding to the layers generated in step S120 ends instep S170.

Steps S150 to S170 are repeated. When the forming of the three-dimensional formed object ends, in step S180, development of the three-dimensional formed object is performed to end the manufacturing method for the three-dimensional formed object in this embodiment.

As explained above, the manufacturing method for the three-dimensional formed object in this embodiment is a manufacturing method for a three-dimensional formed object for manufacturing the three-dimensional formed object by stacking layers. The manufacturing method for the three-dimensional formed object includes a first-layer forming step (corresponding to steps S120 and S130) for supplying a first supply object including a first material to the stage 120 and sintering the first material to thereby solidify the first material to form a first layer and a second-layer forming step (corresponding to steps S140 and S150) for supplying a second supply object including a second material having a melting point or a sintering temperature lower than a sintering temperature of the first material to be superimposed on the first layer and sintering or melting the second material to thereby solidify the second material to form a second layer.

Consequently, it is possible to easily form a discontinuous layer in a state in which the first layer is solidified and a state in which the second layer is solidified. It is possible to easily suppress, by forming the discontinuous layer, the first layer and the second layer from being strongly joined. Forming the discontinuous layer means that the first layer and the second layer are formed such that both of the first layer (the first material) and the second layer (the second material) are not sintered to the same degree. For example, it is possible to easily form the discontinuous layer by sintering the first layer and melting the second layer.

Therefore, it is possible to suppress a situation in which the first material of the first layer serving as a base in forming the three-dimensional formed object and a forming material of the three-dimensional formed object are sintered in the same manner to be strongly joined and a burden of separating work for removing the second layer (the three-dimensional formed object) from the first layer (the base) increases. That is, by using a material having a melting point or a sintering temperature lower than the sintering temperature of the first material as the second material, which is the forming material of the three-dimensional formed object, it is possible to reduce the burden of the separating work for removing the second layer (the three-dimensional formed object) from the first layer (the base).

By forming, using the first material (e.g., ceramics) having small distortion due to heat, the first layer serving as the base (the forming stage) in forming the three-dimensional formed object, it is possible to reduce distortion of the three-dimensional formed object as well and reduce a burden of forming work performed as a post-treatment process.

Expressed in another way, the manufacturing apparatus 2000 for the three-dimensional formed object in this embodiment is a manufacturing apparatus for a three-dimensional formed object that manufactures the three-dimensional formed object by stacking layers. The manufacturing apparatus for the three-dimensional formed object includes a first-layer forming section (the head unit 1800) configured to supply a first supply object including a first material to the stage 120 and sinter the first material to thereby solidify the first material to form a first layer and a second-layer forming section (the head unit 1400) configured to supply a second supply object including a second material having a melting point or a sintering temperature lower than a sintering temperature of the first material to be superimposed on the first layer and sinter or melt the second material to thereby solidify the second material to form a second layer.

Consequently, it is possible to easily form a discontinuous layer in a state in which the first layer is solidified and a state in which the second layer is solidified. It is possible to easily suppress, by forming the discontinuous layer, the first layer and the second layer from being strongly joined. Therefore, it is possible to suppress a situation in which the first material of the first layer serving as a base in forming the three-dimensional formed object and a forming material of the three-dimensional formed object are sintered in the same manner to be strongly joined and a burden of separating work for removing the second layer (the three-dimensional formed object) from the first layer (the base) increases. That is, by using a material having a melting point or a sintering temperature lower than the sintering temperature of the first material as the second material, which is the forming material of the three-dimensional formed object, it is possible to reduce the burden of the separating work for removing the second layer (the three-dimensional formed object) from the first layer (the base).

In the manufacturing method for the three-dimensional formed object according to this embodiment, by repeating steps S150 to S170, it is possible to repeat the supply of the second supply object and the sintering or the melting of the second material and stack one or more layers to form the three-dimensional formed object. Expressed in another way, the manufacturing method for the three-dimensional formed object in this embodiment includes a stacking step (steps S150 to S170) for executing the supply of the second supply object and the sintering or the melting of the second material to stack one or more layers.

Consequently, it is possible to easily form a three-dimensional formed object having a desired shape and a desired size by repeating the stacking step the number of times corresponding to necessity.

In the manufacturing method for the three-dimensional formed object according to the this embodiment, as shown in FIGS. 7B and 7C and FIGS. 8C and 8D, when the seconds supply object is supplied, the second supply object is supplied to not only a corresponding region of the three-dimensional formed object but also a portion other than the corresponding region of the three-dimensional formed object. Expressed in another way, the manufacturing method for the three-dimensional formed object in this embodiment includes a support-layer forming step (steps S150 to S170) for supplying a third supply object (in the embodiment, the second supply object serves as the third supply object as well) and forming a support layer that supports the second supply object supplied in the stacking step. Consequently, when an undercut section (a portion convex in a plane direction with respect to a lower layer) is present in an upper layer among the layers stacked in the stacking step, it is possible support the undercut section with the support layer.

Note that, in the manufacturing method for the three-dimensional formed object, the supply of the third supply object serves as the supply of the second supply object as well (i.e., the third supply object and the second supply object are supplied as the same supply object). However, the third supply object and the second supply object may be supplied as different supply objects by different supply mechanisms.

In the manufacturing method for the three-dimensional formed object in this embodiment, the state 120 is made of metal. Consequently, a melting point of the stage 120, which is the supporting body, is lower than the sintering temperature of the first material (ceramics). That is, the sintering temperature of the first material is different from not only the melting point and the sintering temperature of the second material but also the melting point or the sintering temperature of the stage 120. Therefore, it is possible to not only reduce the burden of the separating work for removing the second layer from the first layer but also reduce a burden of separating work for removing the first layer from the stage 120.

Expressed in another way, in the manufacturing method for the three-dimensional formed object in this embodiment, a coefficient of linear expansion of the first material (ceramics) is different from a coefficient of linear expansion of the second material (metal) and a coefficient of linear expansion of the stage 120 (metal). Consequently, it is possible to reduce the burden of the separating work for removing the second layer from the first layer and the burden of the separating work for removing the first layer from the stage 120.

Note that, by selecting, as the first layer (the first material), a material having a coefficient of linear expansion smaller than the coefficients of linear expansion of the second layer (the second material) and the supporting body, thermal distortion due to heating during the sintering or the melting is reduced. It is possible to suppress distortion of the three-dimensional formed object. Therefore, it is particularly desirable that the coefficient of linear expansion of the first material is smaller than the coefficient of linear expansion of the second material and the coefficient of linear expansion of the supporting body.

In the manufacturing method for the three-dimensional formed object in this embodiment explained with reference to FIGS. 8A to 8H, as shown in FIG. 8A, in the first-layer forming step, it is possible to form the first layer such that the through-holes H piercing to the stage 120 are formed. Consequently, as shown in FIG. 8B, by supplying the second material, which is metal having high thermal conductivity, to the through-holes H, it is possible to allow heat involved in the sintering or the melting of the second material to escape via the through-holes H. As shown in FIG. 8C, by supplying the second material to the through-holes H and sintering or melting the second material to form the second layer together with this portion, it is possible to increase a fixing force of the second layer to the first layer (prevent the second layer from moving with respect to the first layer during the manufacturing of the three-dimensional formed object).

In the manufacturing method for the three-dimensional formed object in this embodiment, the first supply object and the second supply object are supplied by the first-material discharging section 1630 and the second-material discharging sections 1230, which are the noncontact jet dispensers. The noncontact jet dispensers are capable of discharging and disposing the material at a short cycle. Consequently, it is possible to increase manufacturing speed of the three-dimensional formed object. Therefore, at least one of the first supply object and the second supply object is desirably supplied by the noncontact jet dispenser.

At least one of the first supply object and the second supply object maybe supplied by a needle dispenser. The needle dispenser is capable of finely adjusting an amount of the material and disposing the material. Therefore, it is possible to increase the manufacturing accuracy of the three-dimensional formed object.

The first material desirably includes at least one of alumina, silica, aluminum nitride, silicon carbide, and silicon nitride and the second material desirably includes at least one of magnesium, iron, copper, cobalt, titanium, chrome, nickel, aluminum, maraging steel, stainless steel, cobalt chrome molybdenum, a titanium alloy, a nickel alloy, an aluminum alloy, a cobalt alloy, and a cobalt chrome alloy. By using such materials, it is possible to reduce post-treatment processes for the three-dimensional formed object to be manufactured and it is possible to manufacture a three-dimensional formed object having particularly high rigidity.

However, the manufacturing method for the three-dimensional formed object is not limited to such a configuration. It is also possible to use a resin material and the like as the first material and the second material.

Temperature for solidifying (sintering or melting) the second material in the second-layer forming step is desirably equal to or lower than the sintering temperature of the first material. This is because it is possible to suppress a situation in which both of the first layer and the second layer are sintered and strongly joined and the burden of the separating work for removing the second layer from the first layer increases.

The invention is not limited to the embodiment explained above and can be realized in various configurations without departing from the spirit of the invention. For corresponding to the technical features in the aspects described in the summary can be replaced or combined as appropriate in order to solve a part or all of the problems or achieve a part or all of the effects. Unless the technical features are explained in this specification as essential technical features, the technical features can be deleted as appropriate.

The entire disclosure of Japanese patent No. 2015-203473, filed Oct. 15, 2015 is expressly incorporated by reference herein.

What is claimed is:

1. A manufacturing method for a three-dimensional formed object for manufacturing the three-dimensional formed object by stacking layers, the manufacturing method for the three-dimensional formed object comprising:
forming a first layer by supplying a first supply object including a first material to a supporting body and sintering the first material to thereby solidify the first material; and
forming a second layer by supplying a second supply object including a second material having a melting point or a sintering temperature lower than a sintering temperature of the first material to be superimposed on the first layer and sintering or melting the second material to thereby solidify the second material.

2. The manufacturing method for the three-dimensional formed object according to claim 1, further comprising stacking one or more layers by executing the supply of the second supply object and the sintering or the melting of the second material on the second layer.

3. The manufacturing method for the three-dimensional formed object according to claim 2, further comprising supplying a third supply object and forming a support layer that supports the second supply object supplied in the stacking one or more layers.

4. The manufacturing method for the three-dimensional formed object according to claim 1, wherein a melting point of the supporting body is lower than the sintering temperature of the first material.

5. The manufacturing method for the three-dimensional formed object according to claim 1, wherein a coefficient of linear expansion of the first material is smaller than a coefficient of linear expansion of the second material and a coefficient of linear expansion of the supporting body.

6. The manufacturing method for the three-dimensional formed object according to claim 1, wherein, in the forming the first layer, a through-hole piercing to the supporting body is formed in the first layer.

7. The manufacturing method for the three-dimensional formed object according to claim 1, wherein at least one of the first supply object and the second supply object is supplied by a noncontact jet dispenser.

8. The manufacturing method for the three-dimensional formed object according to claim 1, wherein at least one of the first supply object and the second supply object is supplied by a needle dispenser.

9. The manufacturing method for the three-dimensional formed object according to claim 1, wherein
the first material includes at least one of alumina, silica, aluminum nitride, silicon carbide, and silicon nitride, and
the second material includes at least one of magnesium, iron, copper, cobalt, titanium, chrome, nickel, aluminum, maraging steel, stainless steel, cobalt chrome molybdenum, a titanium alloy, a nickel alloy, an aluminum alloy, a cobalt alloy, and a cobalt chrome alloy.

10. The manufacturing method for the three-dimensional formed object according to claim 1, wherein temperature for solidifying the second material in the forming the second layer is equal to or lower than the sintering temperature of the first material.

11. A manufacturing apparatus for a three-dimensional formed object that manufactures the three-dimensional formed object by stacking layers, the manufacturing apparatus for the three-dimensional formed object comprising:
a first-layer forming section configured to supply a first supply object including a first material to a supporting body and sinter the first material to thereby solidify the first material to form a first layer; and
a second-layer forming section configured to supply a second supply object including a second material having a melting point or a sintering temperature lower than a sintering temperature of the first material to be superimposed on the first layer and sinter or melt the second material to thereby solidify the second material to form a second layer.
